(19) United States
(12) Patent Application Publication
(10) Pub. No.: US 2005/0128518 A1
(43) Pub. Date: Jun. 16, 2005

(54) Apparatus, method and program for editing images

(75) Inventors: Takashi Tsue, Kanagawa-ken (JP); Koichi Yamada, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/007,929

(22) Filed: Nov. 29, 2004

(30) Foreign Application Priority Data
Nov. 27, 2003 (JP) (PAT.)396847/2003
Nov. 25, 2004 (JP) (PAT.)340464/2004

(51) Int. Cl. G06K 1/00

(52) U.S. Cl. 358/1.15

(57) ABSTRACT

When a user who once ordered generation of a photo album of an event such as a wedding orders generation of another photo album of the same event by using a different template, image editing can be carried out efficiently. In each order, the template ID used in the order and image specification information identifying selected images are recorded. Correspondence between image insertion areas in templates is recorded as correspondence information. When the order using the differential template is placed, the image specification information and the correspondence information is referred to, and an image editing screen is displayed by inserting the selected images used in the previous order in the image insertion areas in the template used in the present order.

### BACKGROUND OF THE INVENTION

1. Field of the Invention

The present invention relates to an image editing apparatus and an image editing method for selecting an image to be inserted in an image insertion area in a template, and to a program for causing a computer to execute the image editing method.

2. Description of the Related Art

As has been described in Japanese Unexamined Patent Publication No. 9(1997)-214868, a method has been proposed for generating a photo album by reading images from a film with a film scanner and by printing an image including a selected part of the images arranged in desired layout.

In addition, another method has also been proposed in Japanese Unexamined Patent Publication No. 2003-182260 for generating a photo album by printing desired images as photographs and by inserting the photographs in photo mounting corners formed on photo album paper according to a size of the photographs and layout of the photo album.

Meanwhile, in order to generate a photo album of a wedding, a professional photographer sometimes photographs the bride and groom as well as attendants in front of a church as a venue for the wedding or in front of a monument during the wedding. Images obtained in this manner are used to generate a photo album, and the photo album tells a story that can be enjoyed later, since the album traces the behavior of the bride and groom on their wedding day.

In order to generate a photo album, a professional photographer or an operator at a DPE store that provides a photo album generation service (hereinafter collectively referred to as an operator) stores images obtained by photography in an image server, and displays on display means such as a monitor of a workstation a catalog of the images stored in the image server and a template having an image insertion area used for photo album generation. The operator then selects one of the images to be inserted in the image insertion area from the catalog. At this time, the operator carries out image editing processing such as processing to change image quality (blurring or sharpness enhancement, for example), processing to reshape the image (such as rotation, resizing, and trimming), and processing to restore the image (such as red-eye correction and scar removal) on the selected image so that the image inserted in the image insertion area will be attractive.

A photo album is generated by printing images edited in the above manner and pasting the images on photo album paper. A photo album can also be generated by printing composite images having a layout of the photo album, generated from edited images inserted in image insertion areas of a template, as has been described in Japanese Unexamined Patent Publication No. 9(1997)-214868.

Meanwhile, a user who once placed an order for photo album generation on an event may order generation of another photo album of the same event by using another template. In the case where photo albums are generated for the same event as has been described above, images to be used therefor often have similar compositions even if different templates are used. However, an operator needs to display on display means such as a monitor a catalog of images and a template, and has to select images to be inserted in image insertion areas from the catalog in the same manner as in a previous order, which is a burden on the operator.

### SUMMARY OF THE INVENTION

The present invention has been conceived based on consideration of the above circumstances. An object of the present invention is therefore to enable efficient image editing in the case where a user who once placed an order for generation of a photo album orders generation of another photo album of the same event by using a template different from the previous order.

An image editing apparatus of the present invention comprises:
display means for displaying various kinds of information;
image display control means for displaying on the display means a catalog of images related to a predetermined event of a user who placed an order for generating a photo album;
template display control means for displaying on the display means a template selected by the user from a plurality of templates each having at least one image insertion area, together with the catalog of the images;
image selection means for receiving selection of an image or images to be inserted in the image insertion area or areas from the catalog;
image specification information storage means for storing image specification information for the user including a template ID representing the template used for generating the photo album, information for identifying the image or images selected to be inserted in the image insertion area or areas in the template used for generating the photo album, and editing information representing the content of editing processing carried out on the selected image or images; and
template processing means for generating an image-inserted template in the case where the user who placed the order for generation of the photo album orders generation of another photo album regarding the images of the same event with use of a different one of the templates from the previous order, by inserting the image or images selected for insertion in the image insertion area or areas in the template used in the previous order in the corresponding image insertion area or areas of the different template with reference to a template ID of the different template, the image specification information, and the correspondence information, representing correspondence between image insertion areas in each template of the plurality of template types, wherein the template display control means displays the image-inserted template on the display means.

When the image-inserted template is generated by inserting the image or images selected for insertion in the image insertion area or areas in the template used in the previous order in the corresponding image insertion area or areas of the different template, the same editing processing is carried out on the image or images selected for insertion in the image insertion area or areas of the template used in the previous order by referring to the editing information included in the image specification information, and the image or images edited in this manner are inserted in the corresponding image insertion area or areas in the different template. In the case where a size of the image insertion area or areas in the template used in the previous order is different from that of the template used in the present order, the selected image or images are subjected to resizing processing according to the size of the image insertion area or areas of the template used in the present order, and the selected image or images are then inserted therein.

The image editing apparatus of the present invention may further comprise warning means for displaying a warning in the image insertion area or areas in the image-inserted template in the case where an aspect ratio is different between the image insertion area or areas of the template used in the previous order and the corresponding image insertion area or areas of the different template.

Further, the image editing apparatus of the present invention may further include correspondence information storage means for storing the correspondence information.

In the image editing apparatus according to the present invention, a correspondence information generation means for generating the correspondence information may be further provided.

Further, the image editing apparatus according to the present invention further includes a means for recording a try image, which was a candidate for an image, to be inserted in the image insertion area, when an order for using the template was placed in the past.

The template display control means may be a means for displaying a catalog of the try image or images together with the image-inserted template.

Furthermore, the image editing apparatus of the present invention may also comprise guide image display means for displaying in the image insertion area or areas in the template displayed on the display means a guide image or guide images for guiding the image or images to be inserted therein.

Moreover, the image editing apparatus of the present invention may further comprise editing means for editing the image or images inserted in the image insertion area or areas.

An image editing method of the present invention comprises the steps of:
displaying on display means a catalog of images related to a predetermined event of a user who placed an order for generation of a photo album;
displaying on the display means a template selected by the user from a plurality of templates each having at least one image insertion area, together with the catalog;
receiving selection of an image or images to be inserted in the image insertion area or areas from the catalog;
generating an image-inserted template in the case where the user who placed the order for generation of the photo album orders generation of another photo album regarding the images of the same event with use of a different one of the templates from the previous order, by inserting the image or images selected for insertion in the image insertion area or areas in the template used in the previous order in the image insertion area or areas of the different template corresponding to the image insertion area or areas in the template used in the previous order with reference to a template ID of the different template, to image specification information including a template ID of the template used in the previous order, information for identifying the image or images selected for insertion in the image insertion area or areas in the template used in the previous order, and editing information representing the content of editing processing carried out on the selected image or images, and to correspondence information representing correspondence between the image insertion areas in the respective templates of the plurality of template types; and
displaying the image-inserted template on the display means.

The image editing method of the present invention may be provided as a program that causes a computer to execute the image editing method.

According to the present invention, the catalog of the images and the template are displayed on the display means. An operator then selects the image or images to be inserted in the image insertion area or areas in the template. The image specification information is stored for the user who placed the order for generating the photo album, and the image specification information includes the template ID representing the template used for generating the photo album, the information on identifying the image or images selected to be inserted in the image insertion area or areas in the template, and the editing information representing the content of editing processing on the selected image or images. When the user who placed the order for photo album generation orders generation of another photo album regarding the images of the same event by using the different template, the template ID of the different template, the image specification information, and the correspondence information representing correspondence between the image insertion areas of the respective templates are referred to for generating the image-inserted template through insertion of the selected image or images used in the previous order in the corresponding image insertion area or areas of the different template. In this manner, the image-inserted template is displayed on the display means.

Therefore, the operator does not need to repeat an editing operation from the very beginning in the case where the same user orders photo album generation again of the same event. Consequently, a burden on the operator can be reduced and the photo album generation can be carried out efficiently.

In some cases, the aspect ratio is different between the corresponding image insertion areas. For example, an image needs to be inserted in portrait orientation in an image insertion area in one of the templates while an image needs to be inserted in landscape orientation in a corresponding image insertion area in another one of the templates, although the composition thereof is the same. In this case, if the image inserted in the image insertion area in the template used in the previous order is inserted as it is in the corresponding image insertion area of the template used in the present order, the photo album does not look attractive.

For this reason, the warning is displayed in the corresponding image insertion area of the image-inserted template in the case where the aspect ratio is different between the image insertion areas in the template used in the previous order and in the template used in the present order. In this manner, the operator can be notified of the difference in the aspect ratio and can easily carry out trimming or the like on the image to be inserted in the image insertion area having the different aspect ratio.

### BRIEF DESCRIPTION OF THE DRAWINGS

FIG. 1 is a block diagram showing the configuration of an image editing system comprising an image editing apparatus of an embodiment of the present invention;

FIG. 2 is a block diagram showing the configuration of a photo album editing PC;

FIG. 3 shows an example of an editing screen in a first embodiment;

FIG. 4 shows an example of guide image information;

FIG. 5 shows an example of image specification information;

FIG. 6 shows an example of correspondence information in the first embodiment;

FIG. 7 shows correspondence between image insertion areas in a template T1 and in a template T2;

FIG. 8 shows an example of images having the same composition but in different aspect ratios;

FIG. 9 shows an example of layout information; and

FIG. 10 is a flow chart showing a procedure carried out in this embodiment.

FIG. 11 is a diagram illustrating an example of an editing screen in a second embodiment.

FIG. 12 is a diagram illustrating an example of weight information.

FIG. 13 is a diagram illustrating an example of correspondence information in the second embodiment.

FIG. 14 is a diagram illustrating an example of history information generated in a third embodiment.

FIG. 15 is a diagram illustrating an example of the editing screen in the third embodiment.

### DESCRIPTION OF THE PREFERRED EMBODIMENT

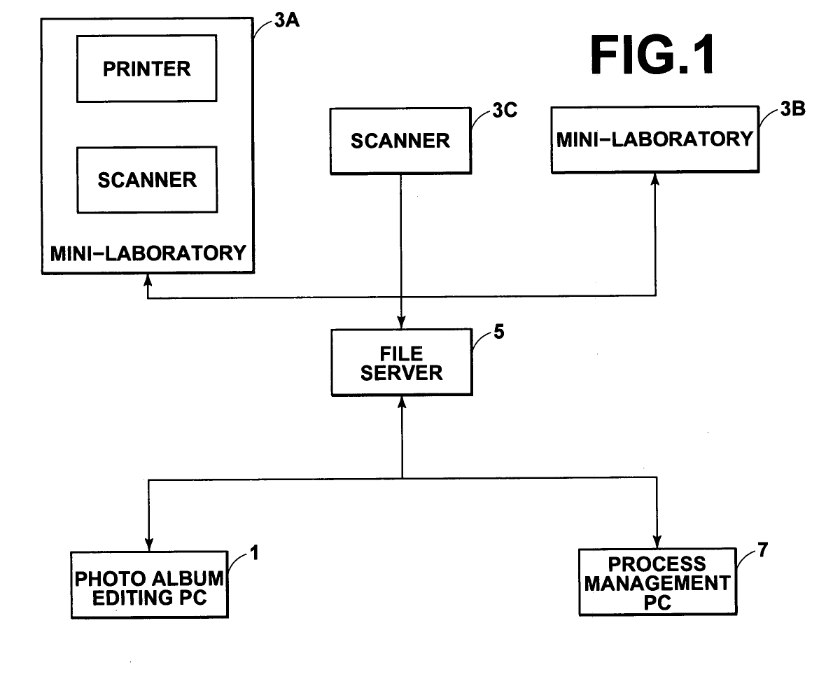

Hereinafter, a first embodiment of the present invention will be described with reference to the accompanying drawings. FIG. 1 is a block diagram showing the configuration of an image editing system comprising an image editing apparatus of the first embodiment of the present invention. As shown in FIG. 1, the image editing system in this embodiment comprises a photo album editing personal computer (hereinafter referred to as the photo album editing PC) 1, a plurality (2, in this case) of mini-laboratories 3A and 3B, a film scanner (hereinafter referred to as a scanner) 3C, a file server 5, and a process management PC 7 connected to each other via a network. The photo album editing PC 1 has functions of the image editing apparatus as the embodiment of the present invention. Each of the mini-laboratories 3A and 3B has a scanner for obtaining image data sets representing images recorded on a developed film by reading the images from the film, and a printer for printing the image data sets. The file server 5 has a large-capacity hard disc for storing the image data sets. The process management PC 7 manages processes of photo album generation.

In this embodiment, the case of a wedding as an event will be described. In the wedding, a professional photographer photographs the bride and groom who requested generation of a photo album (hereinafter referred to as a user) on the day of their wedding, and the photographer generates a photo album telling a story of the event by using the images. However, the event is not necessarily limited to a wedding.

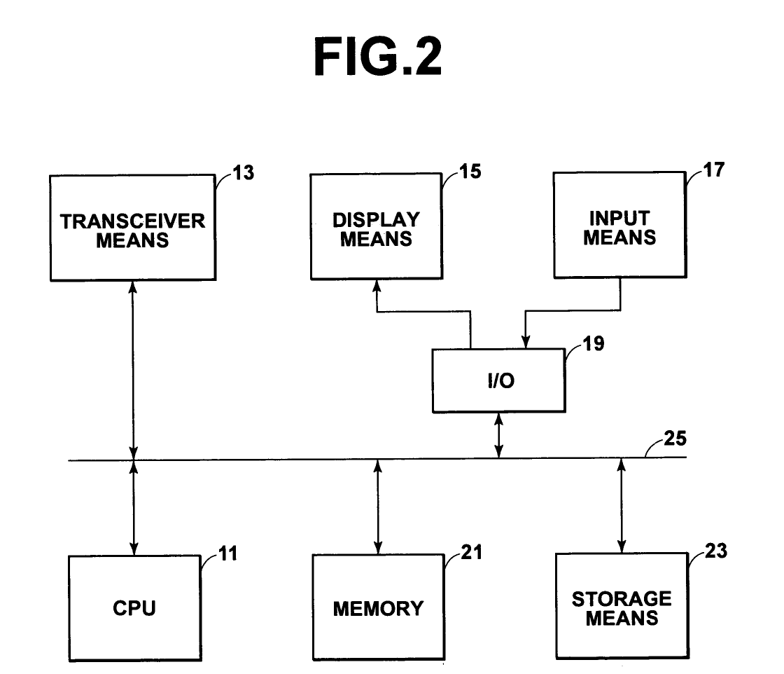

FIG. 2 is a block diagram showing the configuration of the photo album editing PC 1. As shown in FIG. 2, the photo album editing PC 1 comprises a CPU 11 (acting as the image display control means, the template display control means, the template processing means, and the warning means), transceiver means 13 for networking, display means 15, an I/O 19, a memory 21, and storage means 23 (acting as the image specification information storage means and the correspondence information storage means). The CPU 11 controls the photo album editing PC 1. The transceiver means 13 sends and receives various kinds of information including the image data sets to and from the file server 5. The display means 15 displays various kinds of information such as the images and a template. The I/O 19 reads various kinds of information input by an operator of the photo album editing PC 1 via input means 17 (acting as the image selection means) for delivering the information to the CPU 11. The I/O 19 also outputs a display instruction to the display means 15 according to an instruction from the CPU 11. The memory 21 comprises a ROM storing a program for operating the CPU 11 and various constants, and a RAM used by the CPU 11 as a workspace. The storage means 23 comprises a hard disc for storing various kinds of information such as the image data sets.

A bus 25 connects the CPU 11 in the photo album editing PC 1 to peripheral circuits including the transceiver means 13, the I/O 19, the memory 21, and the storage means 23. In this manner, the CPU 11 can control the peripheral circuits. More specifically, the CPU 11 controls the transceiver means 13, the display means 15, the memory 21, and the storage means 23 for reception of information such as the image data sets and template data sets, which will be described later, from the file server 5, for storing the image data sets in the storage means 23, and for displaying a catalog and the template on the display means 15 in order to select a part of the images for insertion in an image insertion area or image insertion areas (hereinafter referred to as the image insertion areas) of the template, to generate image editing information, and to transmit the image editing information to the file server 5 in response to an instruction input from the input means 17 by the operator.

The photo album editing PC 1 receives photo album editing information comprising information on the template specified by the user who requested photo album generation and a user ID when the operator carries out a photo album editing operation. The photo album editing PC 1 sends the photo album editing information to the file server 5, and receives one of the template data sets, the image data sets, and guide image data sets to be inserted in the image insertion areas in the template from the file server 5. The photo album editing PC 1 then reduces the image data sets to generate the catalog of the images represented by the image data sets, and inserts guide images represented by the guide image data sets in the image insertion areas of the template represented by the template data set. In this manner, the photo album editing PC 1 displays an editing screen including the catalog and the template having the guide images inserted therein on the display means 15.

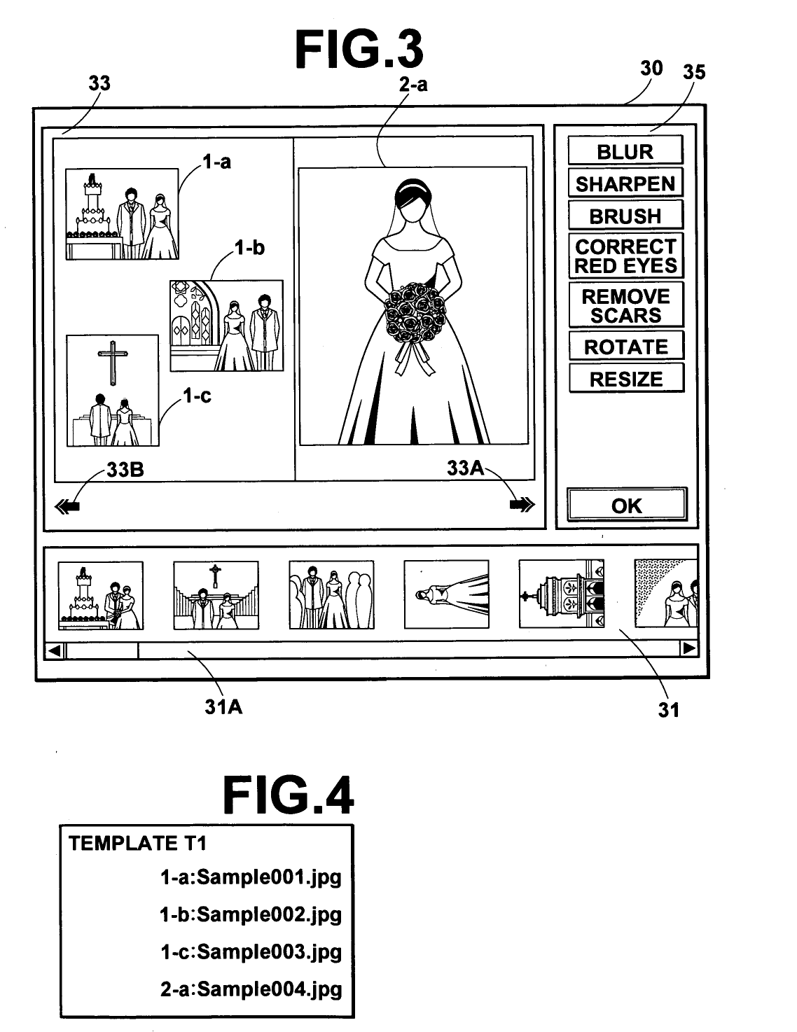

FIG. 3 shows an example of the editing screen. As shown in FIG. 3, an editing screen 30 includes a catalog display field 31 in which the catalog is displayed, a template display field 33 in which the template having the guide images inserted therein is displayed, and a tool box 35.

A scroll bar 31A is displayed in the catalog display field 31. By moving the scroll bar 31A to the right or left, a part of the images that cannot be displayed in one screen can be displayed.

In the example shown in FIG. 3, a template T1 displayed in the template display field 33 includes 4 image insertion areas named 1-a, 1-b, 1-c, and 2-a, all of which respectively have the guide images inserted therein.

The guide images notify the operator who carries out the photo album editing operation of what composition the respective images should have in the corresponding image insertion areas in the template. In the case of photography for generating photo albums of events, the photography is carried out at the same place and in the same situation regardless of who a user as a requester is. For example, in the case of photography of brides and grooms in weddings, photography is carried out at a predetermined place in a hotel and in a predetermined situation such as exchange of marriage rings and cutting a wedding cake.

Therefore, by using the same composition for the images to be inserted in the image insertion areas in the template for all users who selected the same template, a quality of photo albums generated in the above manner can be constant. Consequently, the guide images can be illustrations representing the composition to be inserted in the image insertion areas, drawings, or sample images obtained by photography of a model in the same place or in the same situation, for example. In this embodiment, sample images generated by photographing a model are inserted in the image insertion areas 1-a, 1-b, 1-c, and 2-a.

In a header of the template data set is recorded guide image information relating the image insertion areas 1-a, 1-b, 1-c, and 2-a in the template T1 represented by the template data set to file names of the guide image data sets (sample001.jpg, sample002.jpg, sample003.jpg, and sample004.jpg) to be inserted in the respective image insertion areas, as shown in FIG. 4. The photo album editing PC 1 inserts the guide image data sets in the corresponding image insertion areas of the template by referring to the guide image information recorded in the header of the template image data set.

In the template display field 33 are displayed arrow buttons 33A and 33B for changing a page of the template being displayed in the template display field 33 in the case where the template has a plurality of pages. The operator can change the page of the template to be displayed in the editing screen 30 by clicking the arrow button 33A or 33B.

In the tool box 35 are displayed buttons for carrying out image quality changing processing such as blurring, sharpening, and brushing, buttons for carrying out image restoration processing such as red-eye correction and scar removal, and buttons for carrying out image reshaping processing such as rotation and resizing, and an OK button for ending the processing.

The operator carries out the photo album editing operation by inputting photo album editing instructions while using the editing screen 30. More specifically, the operator selects one of the images having the same composition as the guide image inserted in one of the image insertion areas from the catalog, and drags and drops the selected image by using the input means 17. In this manner, the operator inserts the selected image in the corresponding image insertion area. After the insertion, the operator selects the image insertion area and edits the selected image inserted therein by clicking any one of the buttons in the tool box 35. For example, by clicking the button for rotation, the operator can rotate the image by 90 degrees in the clockwise direction. By clicking the button for resizing, the operator can change the size of the image. Furthermore, by clicking the button for blurring or sharpening or brushing, the quality of the image can be changed. By clicking the button for red-eye correction or scar removal, the image can be restored.

After selecting all the images to be inserted in the respective image insertion areas and editing all the selected images, the operator clicks the OK button to end the photo album editing operation using the template. The photo album editing PC 1 generates the image editing information including the file names of the selected images, information relating the file names of the images to be inserted in the respective image insertion areas and the corresponding image insertion areas, information on the processing to be carried out on the image data sets such as blurring, reduction or enlargement, and red-eye correction, information on an area to be trimmed in the case of trimming, and information on a magnification ratio in the case of reduction or enlargement. The image editing information is sent to the file server 5.

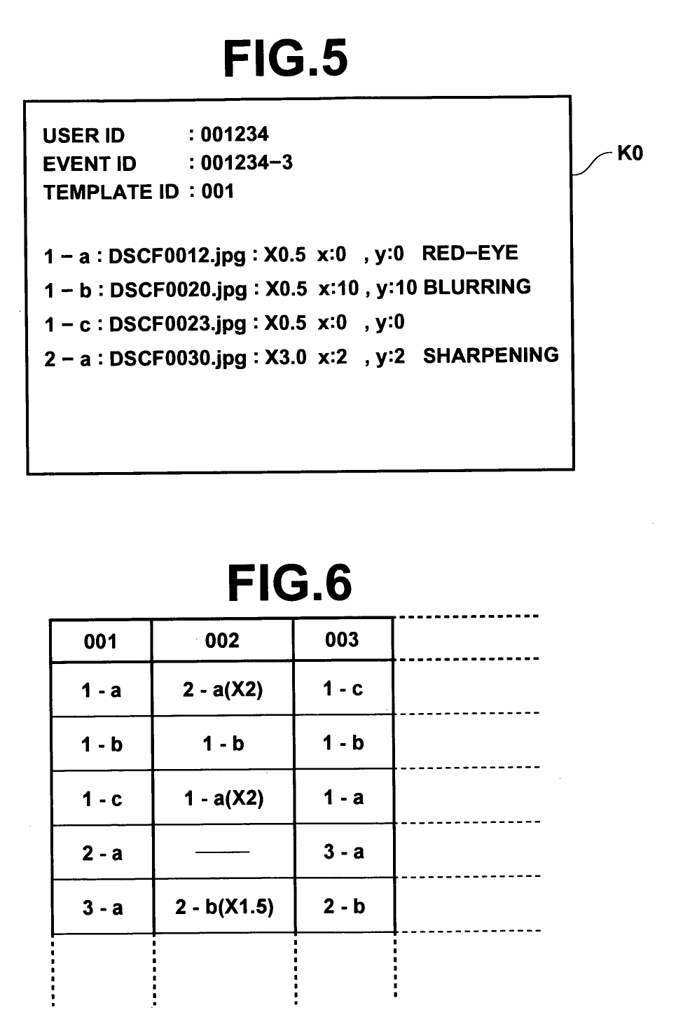

Image specification information KO is stored in the storage means 23 for each user. The image specification information KO includes the template ID representing the template used for photo album generation, the file names of the images selected to be inserted in the image insertion areas of the template, and editing information representing the content of editing processing carried out on the selected images. FIG. 5 shows an example of the image specification information K0. As shown in FIG. 5, the image specification information K0 includes the user ID (001234, in this case), an event ID (001234-3) representing the event, of which the photo album is generated, the template ID (001) representing the template used to generate the photo album, the file names (DSCF001.jpg, DSCF0023.jpg, and the like) of the image data sets selected to be inserted in the image insertion areas (1-a, 1-b, 1-c, and so on), and the editing information representing the content of editing processing carried out on the selected images (such as a magnification ratio 0.5 to an original image, a shift x:0,y:0 of center of the corresponding image, and red-eye correction, for example). The shift represents how much the center of the image is displaced from the center of the corresponding image insertion area, and can be expressed by the number of pixels in x and y directions.

The reference number such as 1-a, of each of the image insertion areas, represents a page number and a symbol of each of the image insertion areas in the page in the template. For example, the template represented by the template ID 001 in the image specification information K0 shown in FIG. 5 has a plurality of pages, and the first page has the 3 image insertion areas 1-a, 1-b, and 1-c.

The storage means 23 also stores correspondence information C0 representing correspondence between image insertion areas in respective templates used for photo album generation. In other words, the correspondence information C0 represents which of the image insertion areas has the same composition in the templates. FIG. 6 shows an example of the correspondence information C0. As shown in FIG. 6, the correspondence information C0 includes the template IDs (001, 002, 003 and so on) and the correspondence between each of the image insertion areas in each of the templates represented by the template ID to the other image insertion areas of the other templates.

For example, the image insertion area 1-a of the template having the template ID 001 (the template T1) corresponds to an image insertion area 2-a of the template whose ID is 002 (hereinafter referred to as a template T2) and to an image insertion area 1-c of the template whose ID is 003 (hereinafter referred to as a template T3). The image insertion area 1-b in the template T1 corresponds to an image insertion area 1-b in the template T2 and to an image insertion area 1-b in the template T3. The image insertion area 2-a in the template T1 does not correspond to any image insertion areas in the template T2 but corresponds to an image insertion area 3-a in the template T3. Values such as X2 in a column of the template ID 002 in FIG. 6 show the magnification ratio to the corresponding image insertion area in the template T1. For example, the size of the image insertion area 2-a in the template T2 is twice as large as that of the corresponding image insertion area 1-a in the template T1.

The user who once placed the order for generation of the photo album may order generation of another photo album of the same event by using a different one of the templates. Hereinafter, the order placed first is referred to as the previous order and the order placed for the second time is referred to as the present order. When the operator carries out a photo album editing operation in the present order, the photo album editing PC 1 receives the photo album editing information comprising the user ID and the information on the template selected by the user, in the same manner as in the previous order. The photo album editing PC 11 then sends the photo album editing information to the file server 5, and receives the template data set, the image data sets, and the guide image data sets to be inserted in the image insertion areas in the template from the file server 5. The photo album editing PC 1 reduces the image data sets to generate the catalog.

The photo album editing PC 1 refers to the information on the template selected by the user input by the operator and the image specification information K0 stored in the storage means 23, for judging whether or not the present order has been placed by the same user for generating the photo album from the images of the same event by using the template different from the template used in the previous order. If a result of the judgment is affirmative, the photo album editing PC 1 refers to the correspondence information C0 stored in the storage means 23, and obtains the information on the correspondence between the image insertion areas in the template used in the previous order and the image insertion areas in the template to be used in the present order. The photo album editing PC 1 further refers to the image specification information K0 on the user, and generates an image-inserted template by inserting the images selected for insertion in the image insertion areas in the template used in the previous order in the corresponding image insertion areas in the template used in the present order instead of the guide images. The photo album editing PC 1 displays the image-inserted template in the template display field 33 in the editing screen 30. The images inserted in the image insertion areas have been subjected to the editing processing based on the editing information in the image specification information K0.

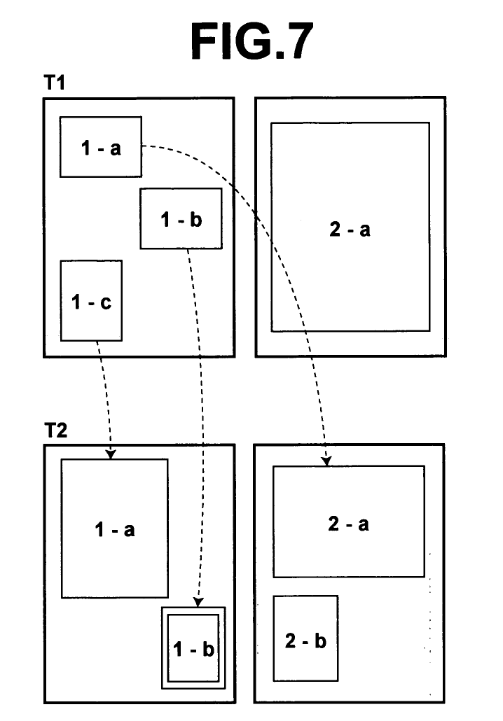

In the case where the user selected the template T1 whose ID is 001 in the previous order and uses the template T2 having the ID 002 in the present order, the image insertion areas in the templates T1 and T2 correspond as shown in FIG. 7, according to the correspondence information C0 shown in FIG. 6. Therefore, the photo album editing PC 1 carries out the editing processing on the image whose file name is DSCF0012.jpg inserted in the image insertion area 1-a in the template T1, and inserts the edited image in the image insertion area 2-a in the template T2 by referring to the image specification information K0. The photo album editing PC 1 also carries out the editing processing on the images having the file names DSCF0020.jpg and DSCF0023.jpg inserted respectively in the image insertion areas 1-b and 1-c in the template T1, and inserts the edited images in the image insertion areas 1-b and 1-a in the template T2. In this manner, the photo album editing PC 1 generates the image-inserted template.

The photo album editing PC 1 carries out the editing processing on the images by referring to the magnification ratio to the image insertion areas in the template T1 included in the correspondence information C0. For example, the image inserted in the image insertion area 1-a in the template T1 is generated by reducing the original image to 50% (that is, a magnification ratio of 0.5). Meanwhile, the image insertion area 2-a in the template T2 corresponding to the image insertion area 1-a in the template T1 is twice as large as the image insertion area 1-a in the template T1. Therefore, the photo album editing PC 1 inserts the image in the image insertion area 2-a in the template T2 after magnifying the original image to 0.5×2=1 (that is, no reduction or enlargement) and carrying out the red-eye correction processing thereon.

For the image insertion area having no corresponding image insertion area, the corresponding guide image fills the image insertion area.

The operator can carry out the photo album editing operation in the same manner as in the previous order, by referring to the editing screen 30.

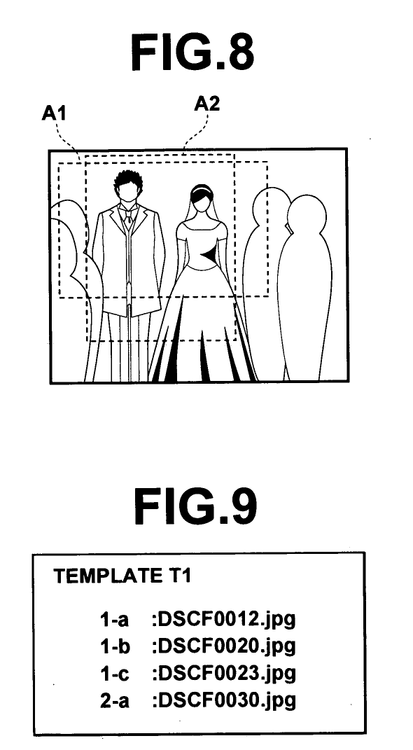

The image insertion area 1-b in the template T1 corresponds to the image insertion area 1-b in the template T2, as shown in FIG. 7. However, the former has a horizontally elongated shape while the latter has a vertically elongated shape. Therefore, the aspect ratio is different between the image insertion areas. In the case where the aspect ratio is different between the image insertion areas corresponding to each other (that is, having the same composition), the operator is expected to carry out trimming on the corresponding image in landscape orientation as shown by an area A1 in FIG. 8 for one of the templates, and to carry out trimming on the corresponding image in portrait orientation as shown by an area A2 for another one of the templates, to cause the respective photo albums to look attractive with the same composition.

In the case where the aspect ratio is different between the two images although the composition thereof is the same, the photo album does not look attractive if the image selected in the previous order is edited in the same manner and inserted in the corresponding image insertion area of the template used in the present order.

For this reason, the photo album editing PC 1 displays a warning in the corresponding image insertion area in the template display field 33 in the editing screen 30 in the present order, in the case where the aspect ratio is different between the image insertion areas corresponding to each other in the templates used in the previous and present orders. More specifically, the warning may be displayed by adding an additional frame to the image insertion area having the different aspect ratio, or changing a color of a frame of the image insertion area from that of the other image insertion areas. Alternatively, the warning may be displayed by reversing the image in the image insertion area, by adding a mark to the image insertion area, or by blinking the image insertion area. In FIG. 7, the warning is displayed by adding the additional frame to an image insertion area 2-b in the template T2.

The file server 5 stores the image data sets obtained by reading the images recorded on the developed film by using the scanner 3C or the mini-laboratory 3A or 3B. The image data sets are recorded in a folder for the user who requested photo album generation. The file server 5 also stores the template data sets representing the templates to be used for photo album generation, as well as the guide image data sets to be inserted in the image insertion areas in the templates.

The file server 5 refers to the photo album editing information sent from the photo album editing PC 1, and sends the template data set representing the template selected by the user, the image data sets stored in the folder corresponding to the user ID, and the guide image data sets representing the guide images to be inserted in the image insertion areas in the selected template to the photo album editing PC 1.

When the image editing information is sent from the photo album editing PC 1, the file server 5 refers to the file names of the image data sets representing the selected images included in the image editing information, and carries out preparatory processing and the editing processing on the selected image data sets for generating processed image data sets. The preparatory processing includes at least one of brightness correction processing, color correction processing and gradation correction processing on the selected image data sets. The editing processing includes the processing specified by the image editing information. More specifically, the editing processing includes the processing for changing image quality such as blurring, sharpening, and brushing, the image reshaping processing such as trimming and enlargement/reduction processing, and the image restoration processing such as red-eye correction and scar removal on the image data sets specified by the image editing information.

The file server 5 generates layout information from the information relating the file names of the image data sets and the image insertion areas of the template included in the image editing information. FIG. 9 shows an example of the layout information. As shown in FIG. 9, the layout information relates the names of the image data sets (DSCF0012.jpg, DSCF0020.jpg, DSCF0023.jpg, and DSCF0030.jpg) and the corresponding image insertion areas 1-a, 1-b, 1-c, and 2-a in the template T1. The file server 5 sends the processed image data sets and the layout information to either the mini-laboratory 3A or 3B.

The process management PC 7 receives information representing completion of the processes such as the photo album editing operation, printing, and photo album inspection input by the operator, in order to manage the processes regarding photo album generation. In the case where the photo album has passed the inspection carried out by the operator for examining the quality of the generated photo album, the process management PC receives information thereon and finishes the process management for the photo album. In the case where the photo album did not pass the inspection, the process management PC 7 receives an instruction to generate the photo album again.

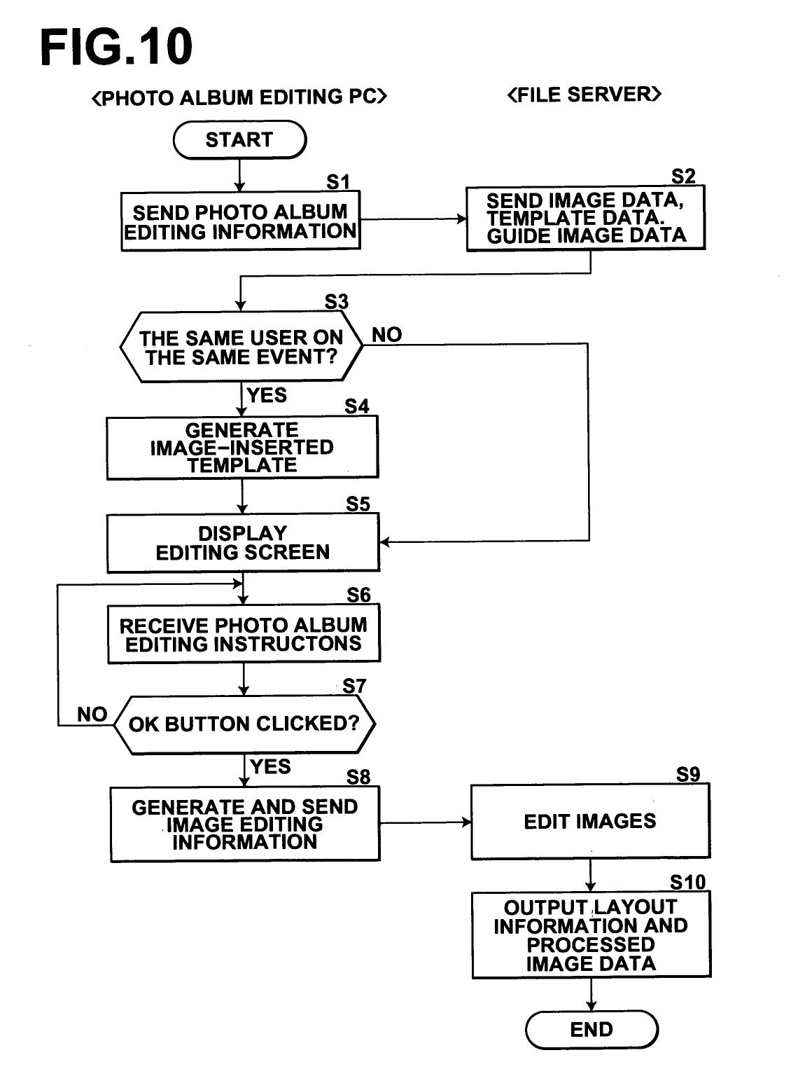

A procedure carried out in the first embodiment will be described next. FIG. 10 is a flow chart showing the procedure. The file server 5 has already stored the image data sets obtained by reading the images from the developed film recorded with photographs on the wedding of the user.

The procedure starts when the operator inputs an instruction to edit the photo album from the photo album editing PC 1. The photo album editing PC 1 sends the photo album editing information including the user ID and the information on the template selected by the user to the file server 5 (Step S1).

The file server 5 receives the photo album editing information, and sends the image data sets stored in the folder corresponding to the user ID, the template data set representing the template selected by the user, and the guide image data sets representing the guide images to be inserted in the image insertion areas in the template to the photo album editing PC 1 (Step S2).

The photo album editing PC 1 receives the image data sets, the template data set, and the guide image data sets, and judges whether or not the order whose photo album editing information has been sent is an order placed by the same user for the same event (Step S3). In other words, whether the same user placed a previous order for the same event is judged at Step S3. If a result at Step S3 is affirmative, the image-inserted template is generated with reference to the correspondence information C0 and the image specification information K0 (Step S4), and the editing screen 30 is displayed on the display means 15 (Step S5). If the result at Step S3 is negative, the procedure goes to Step S5. Since the order is the first order, the editing screen 30 is displayed having the guide images inserted in the corresponding image insertion areas in the template.

The photo album editing PC 1 receives the photo album editing instructions input by the operator referring to the editing screen 30 (Step S6). The photo album editing PC 1 then judges whether or not the OK button has been clicked (Step S7). If a result at Step S7 is affirmative, the photo album editing PC 1 generates the image editing information, and sends the image editing information to the file server 5 (Step S8). If the result at Step S7 is negative, the procedure returns to Step S6 for continuously receiving the editing instructions from the operator.

The file server 5 receives the image editing information, and carries out the editing processing by referring to the file names of the selected image data sets included in the image editing information (Step S9). The file server 5 sends the processed image data sets, generated through the editing processing, and the layout information, generated from the image editing information, to either the mini-laboratory 3A or 3B (Step S10) to end the procedure.

The mini-laboratory 3A or 3B receives the processed image data sets and the layout information, and prints the processed image data sets to generate prints thereof. The operator (or an operator dedicated to photo album binding) pastes the prints in print insertion areas in photo album paper corresponding to the template while referring to the layout information, and carries out binding and the like to generate the photo album.

The operator in charge of quality control inspects the photo album generated in this manner. In the case where the photo album has passed the inspection, the photo album is sent to the user. In the case where the photo album did not pass the inspection, an instruction is input from the process management PC 7 for generating the photo album again.

As has been described above, according to the present invention, when the same user orders photo album generation for the same event with another one of the templates, the images selected for insertion in the image insertion areas in the template used in the previous order are inserted in the corresponding image insertion areas in the template used in the present order with reference to the template ID representing the template used in the present order, the correspondence information C0, and the image specification information K0. The image-inserted template is displayed in the editing screen 30.

Therefore, the operator does not need to repeat the photo album editing operation from the very beginning for the present order, which reduces the burden on the operator. In this manner, the photo album generation can be carried out efficiently.

In the case where the aspect ratio is different between the image insertion areas in the templates used in the previous order and the present order, the warning is displayed in the corresponding image insertion area in the image-inserted template. Therefore, the operator can easily be notified of the difference in aspect ratio. Consequently, the operator can easily carry out trimming again on the image to be inserted in the image insertion area.

In the embodiment described above, the correspondence information C0 is generated in advance, and stored in the storage means 23. However, the operator may generate the correspondence information C0 according to his/her taste. Hereinafter, this is called a second embodiment.

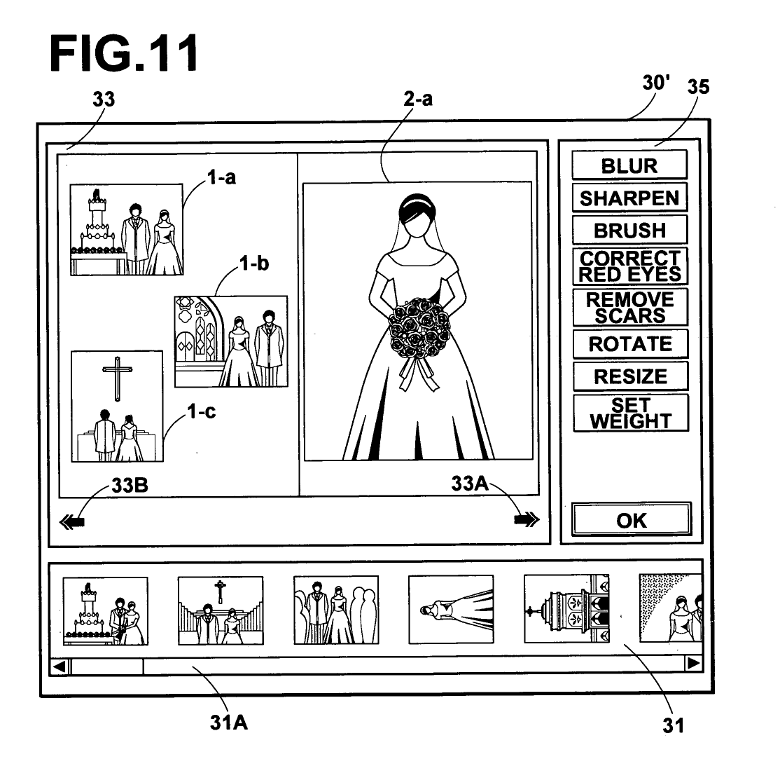

FIG. 11 is a diagram illustrating an editing screen in the second embodiment. As illustrated in FIG. 11, a weight setting button is displayed in the tool box 35 of an editing screen 30′ in the second embodiment.

In the second embodiment, the operator performs a photo album edit operation in a similar manner to the first embodiment as described above. After the operator selects an image, which will be inserted in each of image insertion areas, he/she sets a weight for each of the image insertion areas by using the selected image. Specifically, the operator clicks the weight setting button. Then, he/she sequentially clicks the image insertion areas in an ascending order according to weight while looking at the selected image. Accordingly, the album editing PC 1 sets a weight for each of the image insertion areas. In the second embodiment, a weight 1 is the highest weight, and the larger the value of the weight, the lower the weight. For example, when an album edit operation is performed by using a template T4 with template ID 004, including three image insertion areas 1-a, 1-b, and 1-c on the first page and two image insertion areas 2-a and 2-b on the second page, if the operator clicks the image insertions areas 1-b, 1-a, and 1-c on the first page in this order, weights 1, 2, and 3 are set for each of the image insertion areas 1-b, 1-a, and 1-c, respectively.

In the present embodiment, it is assumed that the weight is set for each page of the template. Therefore, if the operator clicks the image insertion areas 2-b and 2-a in this order on the second page of the template T4, the album editing PCl sets weights 1 and 2 for the image insertion areas 2-b and 2-a, respectively.

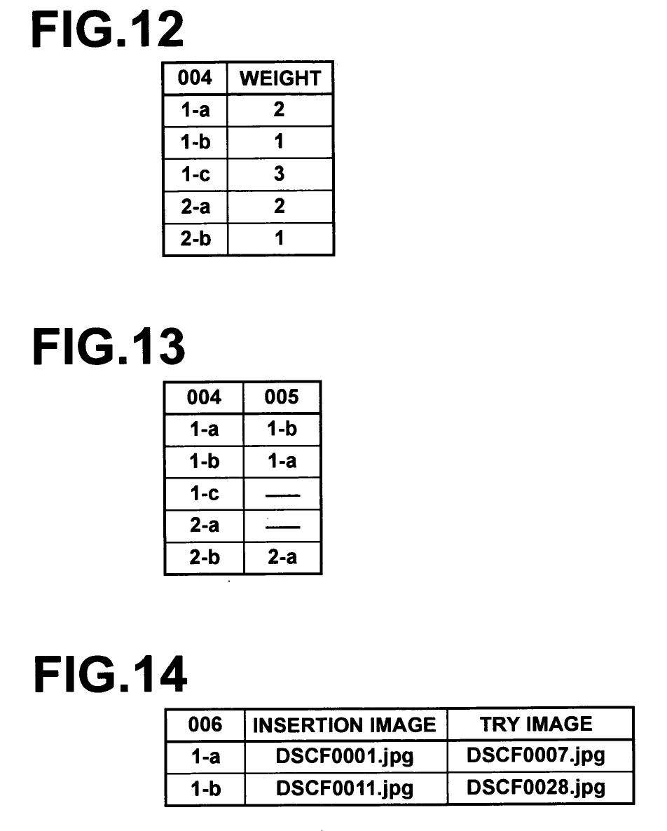

Further, the album editing PC 1 generates weight information about the image insertion areas of the template. FIG. 12 is a diagram illustrating an example of the weight information. As illustrated in FIG. 12, weights 2, 1, 3, 2, 1 are set in image insertion areas 1-a, 1-b, 1-c, 2-a, and 2-b of the template with the template ID 004 according to the order of clicking by the operator as described above.

If the user used the template T4 with the template ID 004 in the previous order, and he/she uses, in a later order, a template T5 with the template ID 005, including two image insertion areas 1-a and 1-b on the first page and one image insertion area 2-a on the second page, the album editing PC 1 refers to the weight information, and generates correspondence information CO between the template T4 and the template T5.

FIG. 13 is a diagram illustrating an example of the correspondence information in the second embodiment. In the second embodiment, it is assumed that weights of image insertion areas in a template, which is used in the later order, are set in an alphabetical order for each page (namely, weight a is the highest weight). Therefore, as illustrated in FIG. 13, image insertion areas 1-b and 1-a in the template T4 corresponds to image insertion areas 1-a and 1-b in the template T5, respectively. An image insertion area 2-b in the template T4 corresponds to an image insertion area 2-a in the template T5.

The album editing PC 1 refers to the correspondence information CO, and generates a template after image insertion by inserting images, selected to be inserted in each of the image insertion areas 1-b, 1-a, and 2-b of the template T4, in the image insertion areas 1-a, 1-b, and 2-a of the template T5. Then, the album editing PC 1 displays the template after image insertion on an editing screen.

After this, the operator may perform album edit operation in a similar manner to the first embodiment as described above.

In the second embodiment as described above, when an edit operation is performed for the later order, the correspondence information C0 is generated. However, the album editing PC 1 may generate correspondence information C0 in advance based on the weights for all templates.

Further, in the second embodiment as described above, the weight is set for the image insertion area by using the image, selected to be inserted in the image insertion area of the template. However, the weight may directly be set in the image insertion area of the template in advance without using the image. Specifically, the operator displays only the template at the album editing PC 1. After the operator clicks the weight setting button on the editing screen 30′, illustrated in FIG. 11, the operator clicks the image insertion areas in the order of weight. Accordingly, the weight is set for each of the image insertion areas. Then, the operator should set the weight for all of the templates, which will be used to produce a photo album, and generates correspondence information C0.

For example, in the template T4 as described above, if the operator clicks the image insertion areas on the first page according to the order of 1-b, 1-a, and 1-c, the album editing PC 1 sets weights 1, 2, and 3 for each of the image insertion areas 1-b, 1-a, and 1-c, respectively. Further, if the operator clicks the image insertion areas on the second page according to the order of 2-b and 2-a, the album editing PC1 sets weights 1 and 2 for each of the image insertion areas 2-b and 2-a. Meanwhile, if the operator clicks the image insertion areas on the first page of the template T5 according to the order of 1-a and 1-b, the album editing PC 1 sets weights 1 and 2 for each of the image insertion areas 1-a and 1-b, respectively. Since there is only one image insertion area on page 2, weight 1 is set for the image insertion area 2-a. In this case, the album editing PC 1 generates correspondence information C0 similar to the correspondence information illustrated in FIG. 13

Therefore, if the template T4 was in the previous order, and the template T5 is used in a later order, the album editing PC 1 refers to the correspondence information C0 in a similar manner to the second embodiment as described above, and generates a template after image insertion by inserting an image, selected to be inserted in the image insertion area of the template T4, in the image insertion area of the template T5. Then, the album editing PC 1 displays the template after image insertion on an editing screen in the later order.

Next, a third embodiment of the present invention will be described. When a photo album is produced by inserting an image in an image insertion area of a template as described above, an operator performs edit operation by inserting images of a plurality of types in the image insertion area by trial and error, while checking whether the photo album will be produced successfully. In the third embodiment, the file name of an image (referred to as a try image), which was a candidate for an image, to be inserted in the image insertion area, and inserted in the image insertion area during album edit, but not used to produce the photo album, is stored together with the file name of an image, selected to be inserted, as history information in the storage means 23. When an order is placed later, the history file is referred to, and the try image is displayed on an editing screen of the template after image insertion.

Specifically, it is assumed that a template T6 with template ID 006, including two image insertion areas 1-a and 1-b was used in the previous order, and during album edit, after the operator inserted images with file names DSCF0001.jpg and DSCF0007.jpg in the image insertion area 1-a, he/she finally selected an image with file name DSCF0001.jpg. It is also assumed that after the operator inserted images with file names DSCF0011.jpg and DSCF0028.jpg in the image insertion area 1-b, he/she finally selected an image with file name DSCF0011.jpg.

In this case, the album editing PC 1 generates history information representing correspondence between images, selected by the operator to be inserted, and the try image. FIG. 14 is a diagram illustrating an example of the history information generated in the third embodiment. As illustrated in FIG. 14, the history information includes correspondence among image insertion areas of the template, the file names of images (insertion images), selected to be inserted, and the file names of try images. Here, when a photo album edit operation is performed by using the template T7 with the template ID 007, including image insertion areas 1-a, 1-b, 1-c, and 2-a, the album editing PC 1 refers to the correspondence information C0 in the first and second embodiments as described above, and generates a template after image insertion. Then, the album editing PC 1 displays the template after image insertion on the editing screen. Further, the album editing PC 1 refers to the history information, and generates a thumbnail image of try images. The album editing PC 1 displays the thumbnail image of the try images on the editing screen.

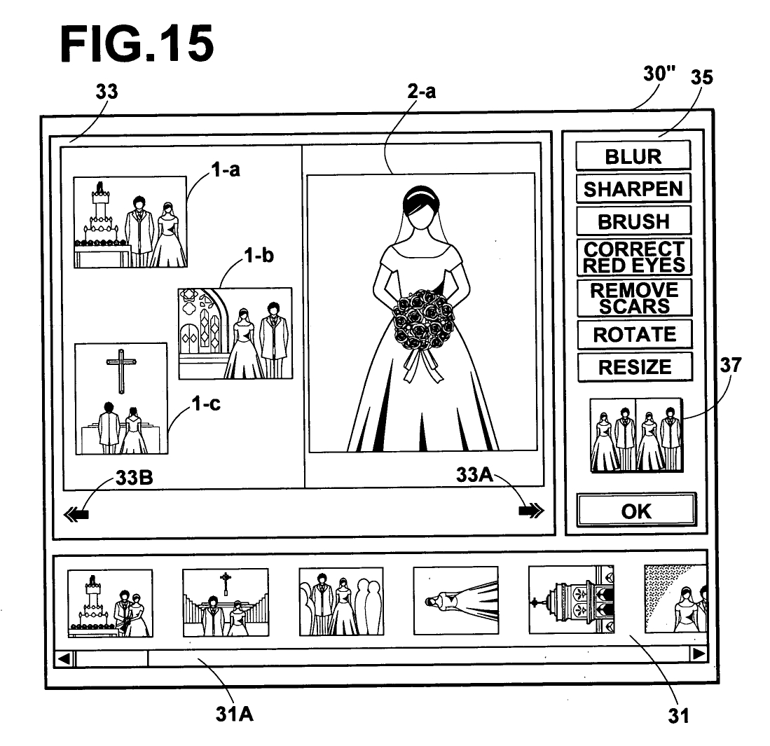

FIG. 15 is a diagram illustrating an example of an editing screen in the third embodiment. As illustrated in FIG. 15, images represented by image data with file names DSCF0001.jpg and DSCF0011.jpg are inserted in the image insertion areas 1-a and 1-b, respectively, on an image editing screen 30″ illustrated in FIG. 15. Guide images are inserted in the image insertion areas 1-c and 2-a. A thumbnail display field 37 for displaying the thumbnail image of the try images is displayed in the tool box 35. Then, the operator clicks an image insertion area, and clicks a try image in the thumbnail display field 37. Accordingly, the operator can insert the try image in the clicked image insertion area.

As described above, in the third embodiment, the try image is displayed on the editing screen when an order is placed later. Therefore, especially when the number of image insertion areas in the template, which is used when the later order is placed, is larger, the try image may be inserted in the image insertion area, in which the guide image of the template in the later order is inserted. Therefore, the image, which was used in the previous order, may be referred to. Accordingly, the photo album may be easily produced.

In the third embodiment, if the weight is set for each image or each image insertion area in the same manner as embodiment 2, only the try image in the image insertion area, in which image of which weight is equal to or higher than a predetermined threshold value is inserted, may be displayed on the thumbnail display field 37. Further, as described in the third embodiment, if the number of image insertion areas in the template, which is used when the later order is placed, is larger, the try image in the image insertion area, of which weight is high, may be inserted in the image insertion area of the template, which is used when the later order is placed, instead of the guide image, and a template after image insertion may be generated. The generated template after image insertion may be displayed on the editing screen.

In the embodiment described above, the processed image data sets of the selected images are printed by the mini-laboratory 3A or 3B, and the operator pastes the prints on the photo album paper corresponding to the template to generate the photo album. However, the file server 5 may generate a composite image data set representing an image (a photo album image) having the images selected by the operator and inserted in the image insertion areas in the template by combining the processed image data sets and the template data set. The composite image data set is output to the mini-laboratory 3A or 3B.

If the mini-laboratory 3A or 3B prints the composite image data set generated in this manner, the photo album can be generated by simply binding the print of the photo album image, without pasting the prints on the paper.

In the above-described embodiment, the photo album is generated by using the image data sets obtained by reading the images recorded on the developed film. However, a photo album can be generated by using image data sets obtained by a digital camera. In this case, the file server 5 comprises a media drive for reading the image data sets from a recording medium such as a memory card storing the image data sets obtained by photography. The image data sets read from the recording medium by the media drive are stored in the file server 5.

In the above-described embodiment, the file server 5 carries out the preparatory processing only on the image data sets selected by the operator of the photo album editing PC 1. However, all the image data sets may be stored in the file server 5 after the preparatory processing carried out thereon at the time of reception of the image data sets from the mini-laboratory 3A or 3B or from the scanner 3C. Furthermore, the photo album editing PC 1 may carry out the preparatory processing on all the image data sets sent from the file server 5 or on the image data sets selected for the photo album generation.

In each of the embodiments as described above, the photo album editing PC 1 or the file server 5 may generate, based on layout information, data (album data) including a user image inserted in a template, and the data may be sent to a server or like, which can be accessed by the user, and stored. Accordingly, the user can check whether the photo album will be successfully produced before actual production of the photo album. Further, in this case, the user may select whether the photo album is produced by using the album data or the photo album is reedited.

1. An image editing apparatus comprising:
display means for displaying various kinds of information;
image display control means for displaying on the display means a catalog of images related to a predetermined event of a user who placed an order for generating a photo album;
template display control means for displaying on the display means a template selected by the user from a plurality of templates each having at least one image insertion area, together with the catalog of the images;
image selection means for receiving selection of an image or images to be inserted in the image insertion area or areas from the catalog;
image specification information storage means for storing image specification information for the user including a template ID representing the template used for generating the photo album, information for identifying the image or images selected to be inserted in the image insertion area or areas in the template used for generating the photo album, and editing information representing the content of editing processing carried out on the selected image or images; and
template processing means for generating an image-inserted template in the case where the user who placed the order for generation of the photo album orders generation of another photo album regarding the images of the same event with use of a different one of the templates from the previous order, by inserting the image or images selected for insertion in the image insertion area or areas in the template used in the previous order in the corresponding image insertion area or areas of the different template with reference to a template ID of the different template, the image specification information, and correspondence information, representing correspondence between image insertion areas in each template of the plurality of template types, wherein
the template display control means displays the image-inserted template on the display means.

2. The image editing apparatus according to claim 1 further comprising warning means for displaying a warning in the image insertion area or areas in the image-inserted template in the case where an aspect ratio is different between the image insertion area or areas of the template used in the previous order and the corresponding image insertion area or areas of the different template.

3. The image editing apparatus according to claim 1, further comprising:
correspondence information storage means for storing the correspondence information,

4. The image editing apparatus according to claim 1, further comprising:
correspondence information generation means for generating the correspondence information.

5. The image editing apparatus according to claim 1, further comprising:
a means for recording a try image, which was a candidate for an image, to be inserted in the image insertion area, when an order for using the template was placed in the past, wherein the template display control means is a means for displaying a catalog of the try image or images together with the image-inserted template.

6. The image editing apparatus according to claim 1, wherein, in the case where a size is different between the image insertion area or areas in the template used in the previous order and the corresponding image insertion area or areas in the different template, the template processing means resizes the image or images selected for insertion in the image insertion area or areas in the template used in the previous order to the size of the corresponding image insertion area or areas in the different template.

7. The image editing apparatus according to claim 1, wherein the templates are templates for wedding.

8. The image editing apparatus according to claim 1 further comprising guide image display means for displaying in the image insertion area or areas in the template displayed on the display means a guide image or guide images for guiding the image or images to be inserted therein.

9. The image editing apparatus according to claim 1 further comprising editing means for editing the image or images inserted in the image insertion area or areas.

10. The image editing apparatus according to claim 6, wherein the editing means carries out at least one of processing for changing a quality of the image or images, processing for reshaping the image or images, and processing for restoring the image or images on the image or images.

11. An image editing method comprising the steps of:
displaying on display means a catalog of images related to a predetermined event of a user who placed an order for generation of a photo album;
displaying on the display means a template selected by the user from a plurality of templates each having at least one image insertion area, together with the catalog;
receiving selection of an image or images to be inserted in the image insertion area or areas from the catalog;
generating an image-inserted template in the case where the user who placed the order for generation of the photo album orders generation of another photo album regarding the images of the same event with use of a different one of the templates from the previous order, by inserting the image or images selected for insertion in the image insertion area or areas in the template used in the previous order in the image insertion area or areas of the different template corresponding to the image insertion area or areas in the template used in the previous order with reference to a template ID of the different template, to image specification information including a template ID of the template used in the previous order, information for identifying the image or images selected for insertion in the image insertion area or areas in the template used in the previous order, and editing information representing the content of editing processing carried out on the selected image or images, and to correspondence information representing correspondence between the image insertion areas in the respective templates; and
displaying the image-inserted template on the display means.

12. A program for causing a computer to execute an image editing method comprising the steps of:
displaying on display means a catalog of images related to a predetermined event of a user who placed an order for generation of a photo album;
displaying on the display means a template selected by the user from a plurality of templates each having at least one image insertion area, together with the catalog;
receiving selection of an image or images to be inserted in the image insertion area or areas from the catalog;
generating an image-inserted template in the case where the user who placed the order for generation of the photo album orders generation of another photo album regarding the images of the same event with use of a different one of the templates from the previous order, by inserting the image or images selected for insertion in the image insertion area or areas in the template used in the previous order in the image insertion area or areas of the different template corresponding to the image insertion area or areas in the template used in the previous order with reference to a template ID of the different template, to image specification information including a template ID of the template used in the previous order, information for identifying the image or images selected for insertion in the image insertion area or areas in the template used in the previous order, and editing information representing the content of editing processing carried out on the selected image or images, and to correspondence information representing correspondence between the image insertion areas in the respective templates; and
displaying the image-inserted template on the display means.
